(19) United States
(12) Patent Application Publication
(10) Pub. No.: US 2008/0089569 A1
(43) Pub. Date: Apr. 17, 2008

(54) Selective Fold Removal In Medical Images

(75) Inventors: Padmavathi Sundaram, Palo Alto, CA (US); Daved S. Paik, Half Moon Baiy, CA (US); Eftychis Sifakis, Stanford, CA (US); Christopher F. Beaulieu, Los Altos, CA (US); Ron Fedkiw, Sunnyvale, CA (US); Sandy A. Napel, Menlo Park, CA (US)

Correspondence Address: Miriam Kaplan;Lumen IPS, 2345 Yale Street, 2nd Floor, Palo Alto, CA, 94306, US

(73) Assignee: The Board of Trustees of the Leland Stanford Junior University, Palo Alto, CA (US)

(21) Appl. No.: 11/664,759

(22) PCT Filed: Oct. 14, 2005
(86) PCT No.: PCT/US05/37118

§ 371 Date: Nov. 8, 2007

Related U.S. Application Data
(60) Provisional application No. 60/619,106, filed on Oct. 15, 2004.

(51) Int. Cl. G06K 9/00

(52) U.S. Cl. 382/131

(57) ABSTRACT

A method of selectively removing folds in a medical image is provided. With this method, a medical image is deformed to straighten and flatten folds but not polyps, thus allowing polyps to be identified. In a first step, a 3-dimensional deformable model of the medical image is constructed. This model is set to have a high Young's modulus and a low Poisson's ratio. In a preferred embodiment, the model is a continuum surface model, preferably a quasistatic continuum finite element model. Once the model has been constructed, it is deformed such that folds are removed but polyps remain, allowing polyps to be identified.

### FIELD OF THE INVENTION

The present invention relates generally to computer-aided detection. More particularly, the present invention relates to the detection of polyps in the colon.

### BACKGROUND

Colon cancer is the second leading cause of cancer deaths in the United States, with over 100,000 new cases and over 55,000 deaths expected in 2005. Traditionally, the colon surface is examined using colonoscopy, which involves the use of a lit, flexible fiberoptic or video endoscope to detect small lumps on the colon surface called polyps. Polyps are known to be precursors to colon cancer.

Computed Tomographic Colonography (CTC), under development as a less invasive alternative to colonoscopy, produces 2-d and 3-d images of the colon using computed tomography (CT). In CTC, radiologists examine hundreds of 2-d images and/or 3-d computer graphics renditions of the colonic surface to detect polyps.

Three-dimensional surface images rendered from an internal perspective (“virtual fly-through” or “virtual colonoscopy”) appear similar to those produced by conventional colonoscopy. However, navigation through a tortuous, complex structure like the colon is challenging and, frequently, portions of the colonic surface may be missed, leading to incomplete examinations. Cylindrical and planar map projections have been proposed to increase the viewable surface during fly-through, but the presentation format is unfamiliar and the physician may still not have a complete view.

An alternative approach is to mathematically cut the tubular colon surface and lay it out flat for a comprehensive inspection. To do this, planar cross-sections are computed orthogonal to the central path of the colon. The surface is then unfolded using a Polar-to-Cartesian coordinate transformation. However, in high curvature portions of the path, the surface may either be under- or over-sampled, causing surface features to either appear multiple times or be missed completely. Various methods have been proposed to correct for problems caused by non-uniform sampling. However, no matter which method is used, the output is abundant in haustral folds, which occlude polyps and make it difficult for both visual and computer-aided detection of polyps. Accordingly, there is a need in the art to develop a method of unfolding a 3-dimensional image of the colon surface that allows for uniform sampling, attenuates haustral folds, and preserves polyps.

### SUMMARY OF THE INVENTION

The present invention provides a method of unfolding a medical image. With this method, a medical image is deformed to straighten and flatten folds but not polyps, thus allowing polyps to be identified. In a first step, a 3-dimensional deformable model of the medical image is constructed. This model is set to have a high Young's modulus and a low Poisson's ratio. Preferably, the value for Young's modulus is set to be greater than about 40,000 and the value for Poisson's ratio is set to be less than about 1×10⁻¹⁰. More preferably, the value for Young's modulus is set to be in a range from about 40,000 to about 60,000 and the value for Possion's ratio is set to be in a range from about 1×10⁻¹² to 1×10⁻¹⁰. In a preferred embodiment, the model is a continuum surface model, preferably a quasistatic continuum finite element model. Once the model has been constructed, it is deformed such that folds are removed but polyps remain, allowing polyps to be identified. Polyps may be identified either manually or with computer-aided detection.

Any type of medical image may be used according to the invention, including but not limited to computed tomographic images and magnetic resonance images. In a preferred embodiment, the medical images are from computed tomographic colonoscopy, the folds are colonic folds, and the polyps are colonic polyps.

### BRIEF DESCRIPTION OF THE FIGURES

The present invention together with its objectives and advantages will be understood by reading the following description in conjunction with the drawings, in which:

FIG. 1 shows examples of unfolding phantoms and actual patient data according to the method of the present invention;

FIG. 2 illustrates the importance of neglecting inertial effects when unfolding models according to the method of the present invention.

### DETAILED DESCRIPTION OF THE INVENTION

The present invention provides a method of unfolding medical images by deforming a deformable model based on these images. Preferably, the method starts with creating a triangulated mesh isosurface at the air-mucosa boundary from the image data. Any desired meshing scheme may be used for this purpose. A physics-based model is then imparted to the mesh to physically manipulate it. In a preferred embodiment, a finite element model is used. To construct an FEM model, constitutive equations are written for the mesh material, which describe the relationship between strain (deformation measure) and stress (internal forces). The forces at the mesh nodes are then computed using a discretized version of the constitutive equations.

To flatten folds but not polyps, it is desirable for the mesh material to be soft under small strains, but become very stiff under large strain conditions. A nonlinear elasticity model is preferred over a linear elasticity model for this purpose due to the large deformations required. A preferred model is a neo-hookean elasticity model.

Two important material properties, Young's modulus and Poisson's ratio, need to be set to obtain a model in which deformation causes unfolding of folds without distortion of polyps. Young's modulus is the ratio of longitudinal stress to longitudinal strain (with a force applied in the longitudinal direction), and represents the stiffness of the mesh material. The value of Young's modulus is preferably set to a high value, preferably larger than 40,000, more preferably between 40,000 and 60,000, and most preferably 50,000. A high Young's modulus value causes the mesh material to be stiff enough to allow folds to flatten while polyps remain undistorted. Poisson's ratio is the ratio of axial strain to longitudinal strain in response to a longitudinal stretching force which, in all common materials, causes them to become narrower in cross-section while being stretched. To minimize this contraction, Poisson's ratio should be set to a very small positive number, preferably less than about 1×10⁻¹⁰, more preferably between about 1×10⁻¹² and 1×10⁻¹⁰.

The deformation may be any type of deformation but is preferably stretching. Preferably, to simulate stretching of the surface, external forces are applied to the ends of the mesh material. Positions of mesh nodes are then computed at each step of the simulation. The new positions of the mesh nodes are a function of internal forces, which are computed using the constitutive equations and surface deformation model described above.

In a preferred method, the triangulated mesh material is treated as a particle system. Each node in the mesh is modeled as a particle, having mass, position, velocity, and zero spatial extent, that can respond to various forces.

The motion of a single particle is described by Newton's second law using

f=ma.

Since a=dv/dt and v=dx/dt, this second order equation may be broken down into two first order equations:

dx/dt=v

dv/dt=f/m,

where x, v, and f are 3-vectors and denote the position, velocity and force at a single node in the mesh.

To describe the evolution of a complete deformable surface, the positions, velocities and aggregate forces of all the nodes in the mesh are concatenated into single n-vectors, where n is the number of nodes in the mesh. Thus,

dx/dt=v

dv/dt=M⁻¹f(t,x,v)

where M represents the diagonal mass matrix.

The force f at each node is the sum of the internal and external forces acting on that node. The external forces are the user-supplied time varying input to the system. Preferably, the external forces are pulling forces applied to the ends of the surface being stretched. Internal forces represent the resistance of the material to the external forces applied.

In a preferred embodiment, the response of the model to deformation is spatially invariant. Otherwise, polyps located at different spatial locations will be distorted by different amounts. This can be accomplished by using a continuum surface model. Preferably, it is assumed that the mesh has zero mass, thus giving rise to zero acceleration. This assumption is called the quasistatic assumption, since it neglects inertial effects and solves for static equilibrium at each time step. Thus, in a preferred embodiment, a quasistatic continuum finite element model is used.

If inertial effects are neglected, such that a system has zero acceleration and zero mass,

f(t,x,v)=0.

The quasistatic assumption satisfies this equation by enforcing force equilibrium at every time step, implying

f(xₖ₊₁)=f(xₖ+Δxₖ)=0.

Therefore, at every time step, a linear system must be solved. Preferably, the Newton-Raphson solver is used,

$$f ( {x}_{k} + Δ {x}_{k} ) \approx f ( {x}_{k} ) + Δ {x}_{k} \frac{\partial f}{\partial x} {\vert}_{{x}_{k}} = 0.$$

One can then compute the new nodal positions xₖ₊₁=xₖ+Δxₖ, by computing Δxₖ from,

$$- Δ {x}_{k} \frac{\partial f}{\partial x} {\vert}_{{x}_{k}} = f ( {x}_{k} ) .$$

Note that at every time step, it is necessary to invert the global stiffness matrix

$$\frac{\partial f}{\partial x} ,$$

which is constructed from the contributions of the element stiffness matrices that account for contributions from the individual triangles.

To tie the stiffness matrix

$$\frac{\partial f}{\partial x}$$

to the constitutive model of the material, note that the constitutive model, which typically relates stress to strain, can also be expressed as a relationship between force and strain energy. So,

$$f = - \frac{\partial ψ}{\partial x}$$

where ψ denotes the strain energy.

### EXAMPLES

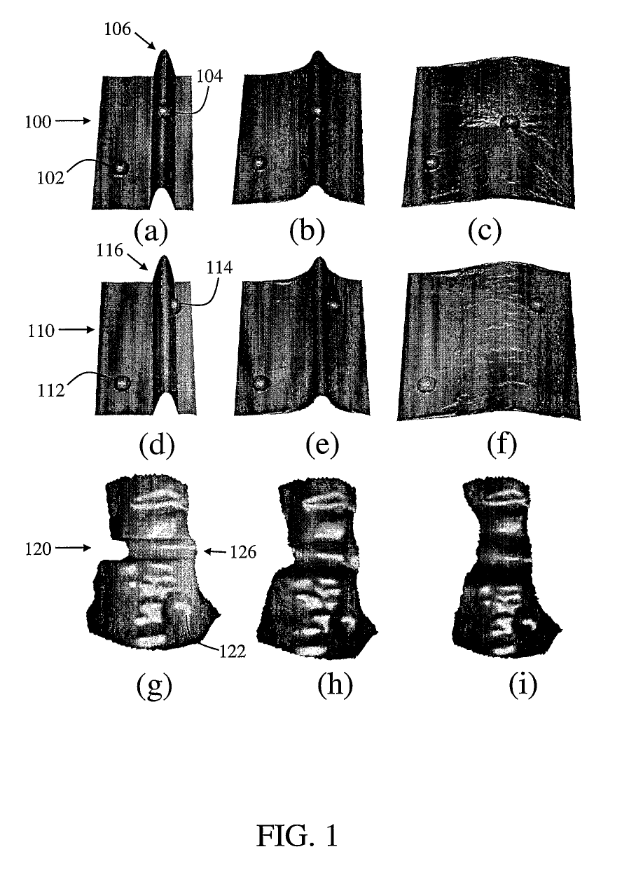

FIG. 1 shows examples of results from deforming phantom and actual patient data that were modeled using the above-described quasistatic continuum finite element model. Each row shows steps in the deformation of a model derived from phantom or actual patient image data. We created mathematical phantoms using MATLAB 7.0.1, with folds and polyps modeled as half sine functions and hemispheres, respectively. FIG. 1(a), (b), and (c) shows a phantom 100 with a polyp 102 on a flat portion in addition to a polyp 104 on top of a fold 106. FIG. 1(d), (e), and (f) shows a phantom 110 with a polyp 112 on a flat portion as well as a polyp 114 on the side of a fold 116. FIG. 1(g), (h), and (i) show a subvolume 120 of actual patient data being stretched. For each case, we measured the curvature and size of polyps (diameters) and folds (height) before and after simulated stretching.

For the phantom in FIG. 1(a-c), the height and curvature of the fold 106 were reduced by 70% and 86.1%, respectively. The polyp 104 on top of the fold 106 was distorted in the stretch direction causing an increase in its maximum width by 16%, and a decrease of 20.2% in its maximum curvature. The size and the curvature of the polyp 102 on the surface remained unchanged. The phantom in FIG. 1(d-f) has polyps on the surface (112) and on the side (114) of the fold 116. The height and curvature of the fold 116 were reduced by 70.3% and 73.5%, respectively. The sizes and curvatures of both polyps remained unchanged.

FIG. 1(g-i) shows stretching of a subvolume 120 of actual patient data, acquired during a computed tomographic colonography (CTC) scan, containing a 6.9 mm polyp. The height and curvature of fold 126 were attenuated by 54.4% and 36.3%, respectively. The polyp 122 was distorted in the stretch direction causing an increase of 10% in its maximum width, and a decrease of 10% in its maximum curvature.

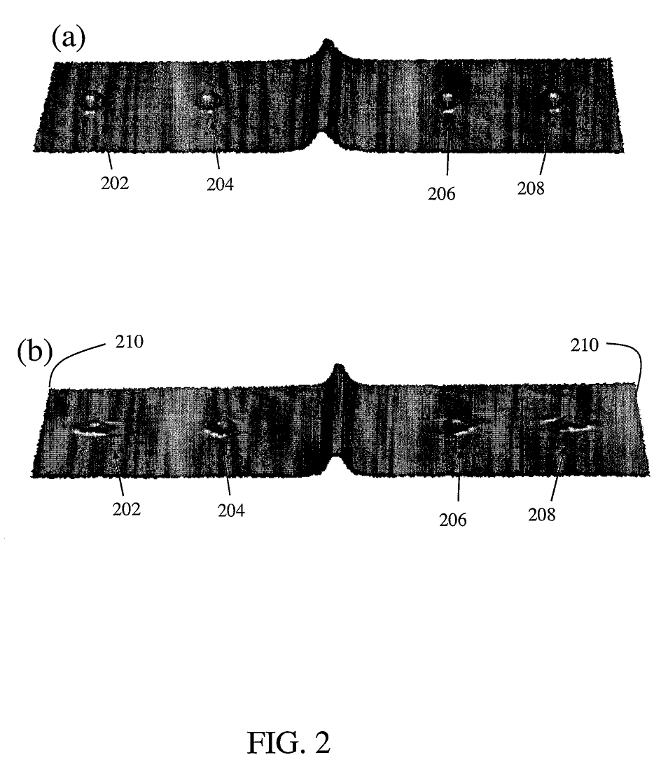

FIG. 2 illustrates the importance of the quasistatic assumption on the unfolding simulation. In FIG. 2, single time points are compared in the simulated stretching of a phantom with polyps and folds, with inertial effects neglected in FIG. 2(a), but not in FIG. 2(b). If inertial effects are neglected (FIG. 2(a)), polyps 202, 204, 206, and 208 are all distorted by the same amount. If inertial effects are not neglected, polyps at different spatial locations are distorted by different amounts, as shown in FIG. 2(b). Specifically, if the phantom is stretched by pulling at edges 210, polyps 202 and 208, which are near edges 210, are distorted more than polyps 204 and 206, which are farther away from edges 210.

Although the present invention and its advantages have been described in detail, it should be understood that the present invention is not limited by what is shown or described herein. As one of ordinary skill in the art will appreciate, the unfolding methods disclosed herein could vary or be otherwise modified without departing from the principles of the present invention. Accordingly, the scope of the present invention should be determined by the following claims and their legal equivalents.

What is claimed is:

1. A method of selectively removing folds in a medical image, comprising:
(a) constructing a 3-dimensional deformable model of said medical image, wherein said 3-dimensional deformable model is constructed to have a high Young's modulus and a low Poisson's ratio;
(b) deforming said 3-dimensional deformable model to flatten said folds; and
(c) identifying polyps in said deformed model.

2. The method as set forth in claim 1, wherein said Young's modulus is set to a value greater than about 40,000.

3. The method as set forth in claim 1, wherein said Young's modulus is set to a value ranging from about 40,000 to about 60,000.

4. The method as set forth in claim 1, wherein said Poisson's ratio is set to a value of less than about 1×10⁻¹⁰.

5. The method as set forth in claim 1, wherein said Poisson's ratio is set to a value ranging from about 1×10⁻¹² to about 1×10⁻¹⁰.

6. The method as set forth in claim 1, wherein said 3-dimensional deformable model is a continuum surface model.

7. The method as set forth in claim 1, wherein said 3-dimensional deformable model is a quasistatic continuum finite element model.

8. The method as set forth in claim 1, wherein said medical image is a computed tomographic image or a magnetic resonance image.

9. The method as set forth in claim 1, wherein said medical image is a computed tomographic colonographic image.
